(19) United States
(12) Patent Application Publication
(10) Pub. No.: US 2020/0377111 A1
(43) Pub. Date: Dec. 3, 2020

(54) TRAINER SYSTEM FOR USE WITH DRIVING AUTOMATION SYSTEMS

(71) Applicant: Honda Motor Co., Ltd, Tokyo (JP)

(72) Inventors: Teruhisa Misu, Mountain View, CA (US); Ashish Tawari, Santa Clara, CA (US); Sujitha Catherine Martin, Sunnvale, CA (US)

(21) Appl. No.: 16/426,689

(22) Filed: May 30, 2019

(51) Int. Cl. B60W 50/06; G06N 20/00

(52) U.S. Cl. CPC B60W 50/06; B60W 2050/0028; G06N 20/00

(57) ABSTRACT

A trainer device trains an automated driver system. The trainer device may include a vehicle manager that manages data associated with controlling a vehicle and a simulation manager that manages data associated with simulating the vehicle. The vehicle manager may analyze vehicle data to identify an intervention event, and the simulation manager obtains a portion of the vehicle data corresponding to the intervention event to generate simulation data, obtains user data associated with the simulation data, analyzes the user data to determine whether the user data satisfies a predetermined intervention threshold, and, on condition that the user data satisfies the predetermined intervention threshold, transmits the user data to the vehicle manager for modifying the first control data.

### BACKGROUND

Some vehicles combine sensor data with artificial intelligence to perform various automated operations. Autonomous vehicles, for example, may traverse areas by detecting and avoiding physical objects around the vehicle. While conventional driving automation systems may be able to handle driving in familiar situations and/or in controlled environments, certain encounters are difficult to navigate and may use human (e.g., driver) intervention because the available data is noisy, sparse, and/or inaccurate.

### SUMMARY

Examples of this disclosure provide opportunities to enhance available data sets for training automated driver systems. In one aspect, a method is provided for training an automated driver system. The method may include analyzing vehicle data to identify an intervention event, using a portion of the vehicle data corresponding to the intervention event to generate simulation data, obtaining user data associated with the simulation data, analyzing the user data to determine whether the user data satisfies a predetermined intervention threshold, and, on condition that the user data satisfies the predetermined intervention threshold, using the user data to modify the first control data.

In another aspect, a trainer device is provided for training an automated driver system. The trainer device may include a vehicle manager that manages data associated with controlling a vehicle and a simulation manager that manages data associated with simulating the vehicle. The vehicle manager may be configured to analyze vehicle data to identify an intervention event, and the simulation manager may be configured to obtain a portion of the vehicle data corresponding to the intervention event to generate simulation data, obtain user data associated with the simulation data, analyze the user data to determine whether the user data satisfies a predetermined intervention threshold, and, on condition that the user data satisfies the predetermined intervention threshold, transmit the user data to the vehicle manager for modifying the first control data.

In yet another aspect, a system is provided. The system may include a vehicle having a plurality of sensors, a plurality of actuators, and an automated driver controller coupled to the sensors and actuators for controlling one or more dynamic driving tasks. A trainer device coupled to the automated driver controller may be configured to analyze vehicle data to identify an intervention event, use a portion of the vehicle data corresponding to the intervention event to generate simulation data, obtain user data associated with the simulation data, analyze the user data to determine whether the user data satisfies a predetermined intervention threshold, and, on condition that the user data satisfies the predetermined intervention threshold, modify the vehicle data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Examples described below will be more clearly understood when the detailed description is considered in conjunction with the accompanying drawings, in which:

FIG. 1 is a block diagram of an example vehicle in an environment;

FIG. 2 is a block diagram of an example driving automation system that may be used to control a vehicle, such as the vehicle shown in FIG. 1;

FIG. 3 is a schematic diagram of an example trainer system that may be used to train a control system, such as the driving automation system shown in FIG. 2;

FIG. 4 is a flowchart of an example method for using the trainer system shown in FIG. 3 to train a control system, such as the driving automation system shown in FIG. 2; and

FIG. 5 is a block diagram of an example computing system that may be used to control a vehicle, such as the vehicle shown in FIG. 1, or train a control system, such as the driving automation system shown in FIG. 2.

It should be noted that these drawings are intended to illustrate the general characteristics of methods, structures, and/or materials utilized in the examples and to supplement the written description provided below. These drawings are not, however, to scale and may not precisely reflect the precise structural or performance characteristics of any given example, and should not be interpreted as defining or limiting the range of values or properties encompassed by the examples.

Corresponding reference characters indicate corresponding parts throughout the drawings. Although specific features may be shown in some of the drawings and not in others, this is for convenience only. In accordance with the examples described herein, any feature of a drawing may be referenced and/or claimed in combination with any feature of any other drawing.

### DETAILED DESCRIPTION

The present disclosure relates to vehicles and, more particularly, to a trainer system for use with automated driver systems. Automated driver systems may allow vehicles to understand its environment and move with little or no human input. Sensor data, for example, may be interpreted to identify one or more routes to a destination. Examples described herein may use sensor data to generate simulation data for presenting one or more simulations to one or more users, and obtain user data for training automated driver systems to perform one or more dynamic driving tasks (e.g., steering, accelerating, and/or braking). Other benefits and advantages will become clear from the disclosure provided herein, and those advantages provided are for illustration.

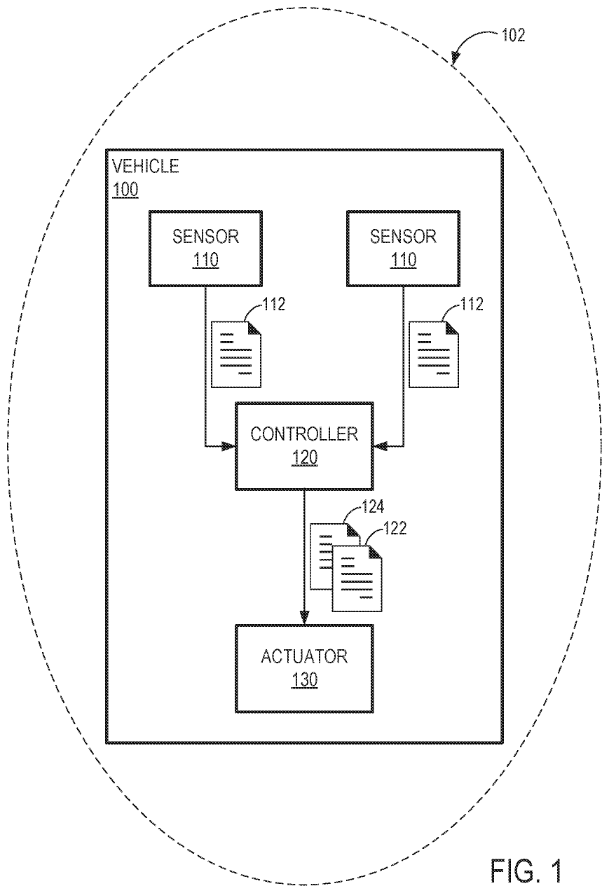

FIG. 1 shows an example vehicle 100 in an environment 102. The vehicle 100 includes a plurality of sensors 110 that may be used to monitor the environment 102. The sensors 110 may generate one or more signals or sensor data 112, for example, based on one or more stimuli detected by the sensors 110. Example sensors 110 include, without limitation, a microphone, an electrostatic sensor, a piezoelectric sensor, a camera, an image sensor, a photoelectric sensor, an infrared sensor, an ultrasonic sensor, a microwave sensor, a magnetometer, a motion sensor, a receiver, a transceiver, and any other device configured to detect a stimulus in the vehicle 100 and/or environment 102. While the vehicle 100 is described and shown to include two sensors 110, the vehicle 100 described herein may include any quantity of sensors 110.

In some examples, the sensors 110 may transmit or provide sensor data 112 to a controller 120 for processing. The sensor data 112 may be processed, for example, to convert the sensor data 112 into one or more other forms (e.g., an analog signal to a digital form), to remove at least some undesired portions (“noise”), and/or to recognize or identify one or more objects in the environment 102. In some examples, the controller 120 may use the sensor data 112 to generate environment data 122. Environment data 122 may include information that enables a computing device (e.g., controller 120) to map or understand the environment 102 and/or various objects in the environment 102.

The controller 120 may also use the sensor data 112 to generate control data 124. Control data 124 may include information that enables a computing device (e.g., controller 120) to control or operate some aspect of the vehicle 100. In some examples, the controller 120 may transmit or provide control data 124 to one or more actuators 130, for example, for steering, accelerating, and/or braking the vehicle 100. The control data 124 may also allow an occupant of the vehicle 100 (e.g., a driver) to control or operate the vehicle 100. While the vehicle 100 is described and shown to include one actuator 130, the vehicle 100 described herein may include any quantity of actuators 130.

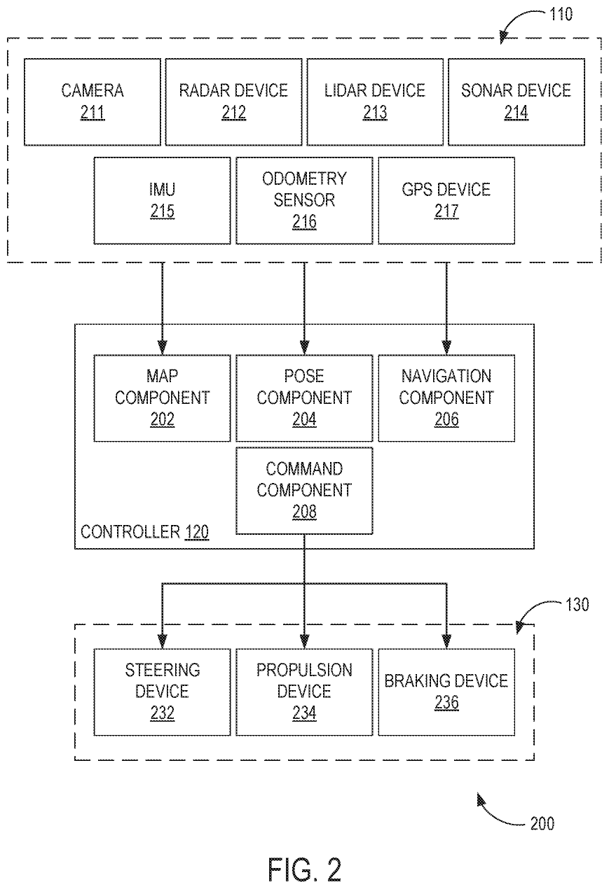

FIG. 2 shows an example automated driver (AD) system 200 including one or more AD controllers (e.g., controller 120) configured to automatically or autonomously control the vehicle 100. The vehicle 100 may operate, for example, in an automated mode, in which the controller 120 controls one or more dynamic driving tasks (e.g., steering, accelerating, and/or braking). The controller 120 may be used to perform one or more operational and/or tactile functions for operating the vehicle 100 in on-road traffic. In some examples, the controller 120 may include a map component 202 configured to construct or update a map of the environment 102 (e.g., environment data 122), a pose component 204 configured to determine or identify a pose (e.g., a position, an orientation, a linear velocity, a linear acceleration, an angular velocity, and/or an angular acceleration, a steering wheel angle, a gas pedal position, a brake pedal position) of the vehicle 100, a navigation component 206 configured to determine or identify one or more routes to a destination, and/or a command component 208 configured to construct or update a control scheme (e.g., control data 124) for controlling or operating the vehicle 100.

In some examples, the controller 120 may be configured to perform one or more operations in real-time or near real-time. For example, the map component 202, pose component 204, navigation component 206, and/or command component 208 may be coupled to a plurality of sensor devices (e.g., sensors 110) that detect one or more stimuli from the environment 102. The sensors 110 may be in any arrangement that enables the map component 202, pose component 204, navigation component 206, and/or command component 208 to function as described herein. As shown in FIG. 2, sensors 110 may include one or more cameras 211, one or more radar devices 212 (e.g., a radio receiver), one or more lidar devices 213 (e.g., a photodetector), one or more sonar devices 214 (e.g., an ultrasonic sensor), one or more inertial measurement units (“IMUs”) 215, one or more odometry sensors 216, and/or one or more global positioning system (“GPS”) devices 217.

The map component 202 may communicate with one or more sensor devices 210 to receive or retrieve sensor data 112, and use the sensor data 112 to generate environment data 122. Environment data 122 may be generated, for example, using a haversine formula, Kalman filter, particle filter, simultaneous localization and mapping (“SLAM”) algorithm, and the like. In some examples, the map component 202 analyzes sensor data 112 to identify one or more features, and clusters or groups the features to identify one or more objects. The features may be grouped, for example, based on one or more commonalities or compatibilities among the features. Correspondingly, the map component 202 may separate one or more features from one or more other features based on one or more differences or incompatibilities between the features.

In some examples, the map component 202 may use one or more annotations or identifiers that allow one or more objects, or one or more characteristics of an object, to be readily recognized or identified (e.g., without re-analyzing sensor data 112 or re-grouping features). The map component 202 may classify or identify an object (e.g., a building, a landmark) as a static object, for example, if a position and/or orientation of the object is the same or substantially similar over time (e.g., based on first sensor data 112 associated with a first point in time and based on second sensor data 112 associated with a second point in time). Additionally or alternatively, the map component 202 may classify or identify an object (e.g., a vehicle or pedestrian) as a dynamic object, for example, if a position and/or orientation of the object changes over time. In some examples, the map component 202 monitors or tracks dynamic objects by collecting data indicative of a level of activity or movement (e.g., maximum speed, average speed, direction), as well as behavior patterns. In this manner, the map component 202 may predict or determine a position and/or orientation of dynamic objects.

The pose component 204 may communicate with the map component 202 and/or one or more sensor devices 210 (e.g., camera 211, radar device 212, lidar device 213, sonar device 214) to identify or confirm a local pose of the vehicle 100 relative to one or more objects in the environment 102 using sensor data 112 and/or environment data 122. Static objects, for example, may be readily used to identify or confirm the local pose of the vehicle 100. Dynamic objects may also be used to identify or confirm the local pose of the vehicle 100, if a position and/or orientation of the object is monitored or tracked over time. In some examples, the pose component 204 communicates with one or more sensor devices 210 (e.g., IMU 215, odometry sensor 216) to receive or retrieve sensor data 112, and use the sensor data 112 to identify or confirm a local pose of the vehicle 100 relative to an initial pose. A position and/or orientation of the vehicle 100, for example, may be monitored or tracked over time (e.g., with respect to the initial pose and/or a local coordinate system). Additionally or alternatively, the pose component 204 may communicate with one or more sensor devices 210 (e.g., GPS device 217) to receive or retrieve sensor data 112, and use the sensor data 112 to identify or confirm a global pose of the vehicle 100.

The navigation component 206 may communicate with the pose component 204 to determine or identify a primary trajectory of the vehicle 100 based on the pose of the vehicle 100, and/or communicate with the map component 202 to determine or identify one or more objects of interest (e.g., objects along or adjacent the planned route, including the projected trajectory). One or more routes may be continuously or iteratively (e.g., at a plurality of times) identified, for example, to account for events and conditions encountered along the route (e.g., a change to the environment 102). In some examples, the navigation component 206 calculates or determines a confidence score that is indicative of the security, reliability, and/or predictability of a planned route based on the objects of interest. For example, objects disposed directly in line with, or likely to be disposed directly in line with, the projected trajectory may be associated with a greater likelihood of collision or obstruction than other objects.

The command component 208 may communicate with the map component 202, pose component 204, and/or navigation component 206 to generate control data 124 based on the routes and their corresponding confidence scores. The vehicle 100 may be operated, for example, to follow a route that corresponds to a higher confidence score (e.g., is likelier to be secure, reliable, and/or predictable). In some examples, the command component 208 provides or transmits the control data 124 to one or more actuator devices (e.g., actuators 130), including one or more steering devices 232 (e.g., a steering wheel), one or more propulsion devices 234 (e.g., a gas pedal), and/or one or more braking devices 236 (e.g., a brake pedal), for controlling a mobility of the vehicle 100. The actuators 130 may be in any arrangement that enables the vehicle 100 to function as described herein.

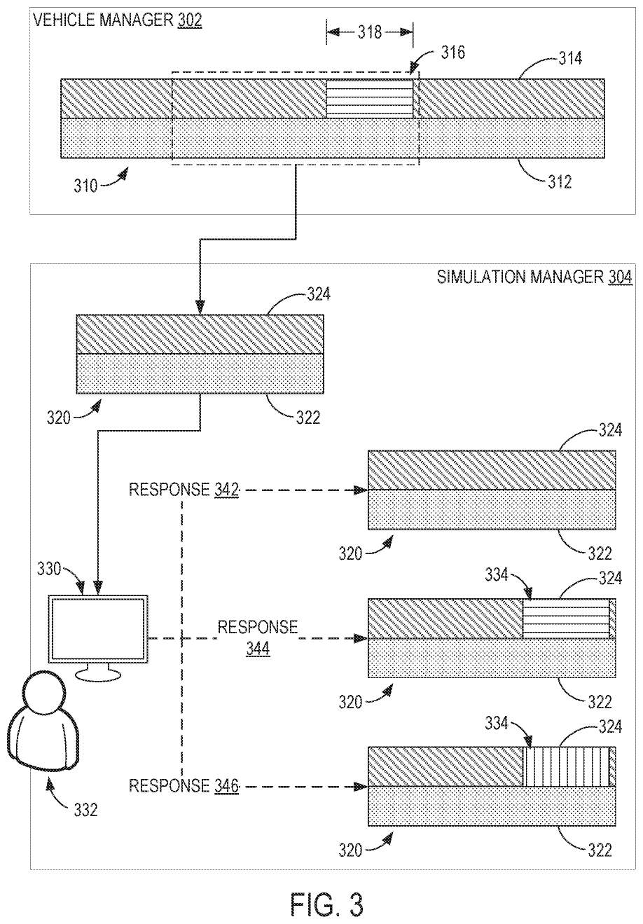

FIG. 3 shows an example trainer device or system 300 that may be used to train a vehicle system (e.g., AD system 200). The trainer system 300 may include, for example, a vehicle manager 302 configured to manage data associated with controlling one or more dynamic driving tasks (e.g., steering, accelerating, and/or braking a vehicle 100), and/or a simulation manager 304 configured to manage data associated with simulating one or more dynamic driving tasks. In some examples, the trainer system 300 is configured to perform one or more operations in real-time or near real-time. For example, the vehicle manager 302 may communicate with the controller 120 to obtain vehicle data 310 (e.g., environment data 122, control data 124) for training the AD system 200. Vehicle data 310 includes environment data 122 (e.g., first environment data 312) and/or control data 124 (e.g., first control data 314). First environment data 312 and/or first control data 314 may include, for example, current and historical environment data 122 and/or control data 124 associated with real-world events. Additionally or alternatively, first environment data 312 and/or first control data 314 may include projected environment data 122 and/or control data 124 determined based on current and/or historical environment data 122 and/or control data 124.

As shown in FIG. 3, a portion 316 (a “first portion”) of the vehicle data 310 may be associated with an intervention event 318. An intervention event 318 may occur, for example, when an occupant of the vehicle 100 (e.g., a driver) takes control of one or more dynamic driving tasks while the vehicle 100 is operating in an automated mode. Additionally or alternatively, an intervention event 318 may occur when the controller 120 takes control of one or more dynamic driving tasks that are otherwise being controlled by the driver of the vehicle 100 (e.g., in a manual mode).

The simulation manager 304 may be configured to generate simulation data 320 associated with the intervention event 318. The simulation data 320 may be generated, for example, based on the first portion 316 of the vehicle data 310. Simulation data 320 may include environment data 122 corresponding to the first environment data 312 (e.g., second environment data 322) and/or control data 124 corresponding to the first control data 314 (e.g., second control data 324). In some examples, the simulation manager 304 uses the simulation data 320 to provide or present one or more simulations in which one or more simulated vehicles 100 are operable in one or more simulated environments 102.

The simulation manager 304 may include or communicate with one or more simulation systems 330 to present the simulations to one or more users 332. In some examples, the simulation manager 304 uses the first portion 316 of the vehicle data 310 to generate first simulation data 320 corresponding to a first situation (e.g., a first combination of environment data 122 and control data 124) and second simulation data 320 corresponding to a second situation (e.g., a second combination of environment data 122 and control data 124). Additionally or alternatively, the simulation manager 304 may use the first portion 316 of the vehicle data 310 to generate first simulation data 320 for presenting a first simulation to a first user 332 and second simulation data 320 for presenting a second simulation to a second user 332.

Each simulation system 330 may monitor or track a respective user 332 to generate user data 334 based on one or more commands and/or other input provided by the user 332 (e.g., in response to the simulations), and transmits or provides the user data 334 to the simulation manager 304. If the user data 334 (or lack thereof) indicates that one or more users 332 did not intervene, as shown at possible response 342 (e.g., the simulated vehicle 100 operated in accordance with the simulation data 320 without user intervention), the simulation manager 304 may determine that the first control data 314 is suitable for navigating the environment 102 and, thus, leave the first control data 314 as is. If, on the other hand, the user data 334 indicates that one or more users 332 intervened, then the vehicle data 310 may be modified based on the user response. For example, if the user data 334 indicates that one or more users 332 intervened in a manner that is the same as or substantially similar to the driver, as shown at response 344 (e.g., the simulated vehicle 100 operated the same as or substantially similar to the vehicle 100), the simulation manager 304 may determine that the driver intervened appropriately and, thus, modify the first control data 314 to imitate or reproduce the driver's intervention. However, if the user data 334 indicates that one or more users 332 intervened in a manner that is different from the driver, as shown at response 346 (e.g., the simulated vehicle 100 operated different from the vehicle 100), the simulation manager 304 may determine that the users 332 intervened appropriately and, thus, modify the first control data 314 to imitate or reproduce the users' intervention.

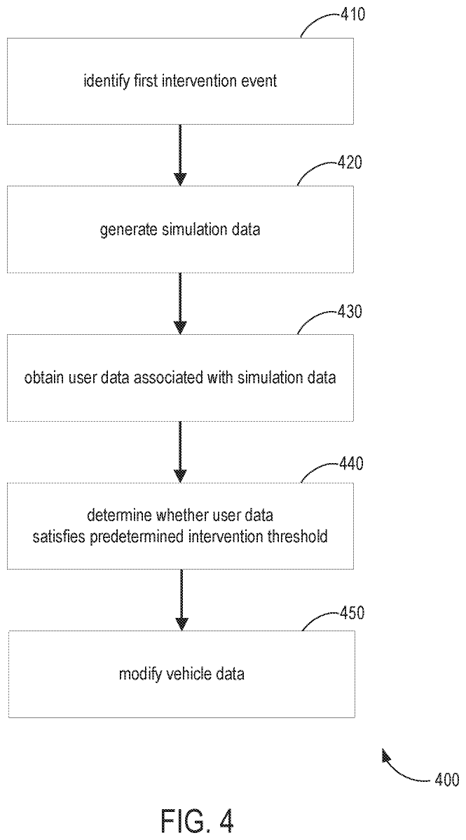

FIG. 4 shows an example method 400 of training an automated driver system (e.g., AD system 200). One or more operations of the method 400 may be implemented, for example, using a trainer system 300.

In some examples, vehicle data 310 is analyzed to identify a first intervention event (e.g., intervention event 318) at operation 410, and a portion of the vehicle data 310 corresponding to the first intervention event (e.g., first portion 316) is used to generate simulation data 320 at operation 420. The vehicle data may be obtained, for example, by communicating with the AD system 200 (e.g., controller 120). In this manner, a situation associated with the first intervention event may be re-created using vehicle data 310 and/or simulation data 320.

User data 334 associated with the simulation data 320 may be obtained at operation 430. In some examples, the trainer system 300 may communicate with a simulation system (e.g., simulation system 330) to present the simulation data 320 to one or more users (e.g., user 332), and the user data 334 is obtained in response to presenting the simulation data 320. In this manner, the trainer system 300 may determine how a user 332 responds to the re-created situation. The user data 334 is analyzed to determine at operation 440 whether the user data 334 satisfies a predetermined intervention threshold (e.g., if there is a second intervention event). On condition that the user data 334 satisfies the predetermined intervention threshold, the simulation data 320 may be used to modify the vehicle data 310 at operation 450. If a user 332 took control over the simulated vehicle 100, it may be determined that the user 332 would not trust the AD system 200 and, thus, the vehicle data 310 may be modified such that an opportunity for the first intervention is removed. First control data 314, for example, may be removed and/or replaced with new control data 124, which may be generated using user data 334. On the other hand, if a user 332 did not take control over the simulated vehicle 100, it may be determined that the user 332 would trust the AD system 200.

In some examples, the trainer system 300 analyzes real-time vehicle data 310 to predict or determine one or more potential intervention events. The trainer system 300 may identify one or more situations rife with potential for intervention (e.g., lane changes, intersections), and generate a simulation for each scenario. In this manner, a plurality of users 332 may provide user data 334 for potentially modifying control data 124 in real time. That is, the user data 334 enables the environment 102 to be tested and/or one or more opportunities to modify control data 124 to be identified.

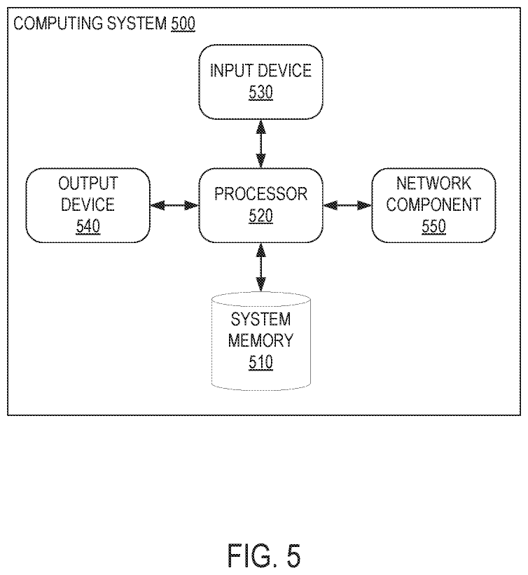

FIG. 5 shows an example computing system 500 configured to perform one or more computing operations. While some examples of the disclosure are illustrated and described herein with reference to the computing system 500 being included in a controller 120 (shown, e.g., in FIG. 1), aspects of the disclosure may be operable with any computing system (e.g., sensor 110, controller 120, actuator 130, AD system 200, map component 202, pose component 204, navigation component 206, command component 208, camera 211, radar device 212, lidar device 213, sonar device 214, IMU 215, odometry sensor 216, GPS device 217, steering device 232, propulsion device 234, braking device 236, trainer system 300, vehicle manager 302, simulation manager 304, simulation system 330) that executes instructions to implement the operations and functionality associated with the computing system 500. The computing system 500 shows only one example of a computing environment for performing one or more computing operations and is not intended to suggest any limitation as to the scope of use or functionality of the disclosure.

In some examples, the computing system 500 may include a system memory 510 and a processor 520 coupled to the system memory 510. The system memory 510 may store data associated with the controller 120 and computer-executable instructions, and the processor 520 is programmed or configured to execute the computer-executable instructions for implementing aspects of the disclosure using the controller 120. The system memory 510 may include one or more computer-readable media that allow information, such as the computer-executable instructions and other data, to be stored and/or retrieved by the processor 520. For example, at least some data may be associated with one or more objects, maps, simulators (e.g., trainer system 300, simulation system 330), one or more control mechanisms (e.g., actuator 130, steering device 232, propulsion device 234, braking device 236), and/or one or more sensors (e.g., sensor 110, camera 211, radar device 212, lidar device 213, sonar device 214, IMU 215, odometry sensor 216, GPS device 217) such that the computer-executable instructions enable the processor 520 to manage or control one or more operations of the controller 120.

By way of example, and not limitation, computer-readable media may include computer storage media and communication media. Computer storage media are tangible and mutually exclusive to communication media. For example, the system memory 510 may include computer storage media in the form of volatile and/or nonvolatile memory, such as read only memory (ROM) or random access memory (RAM), electrically erasable programmable read-only memory (EEPROM), solid-state storage (SSS), flash memory, a hard disk, a floppy disk, a compact disc (CD), a digital versatile disc (DVD), magnetic tape, or any other medium that may be used to store desired information that may be accessed by the processor 520. Computer storage media may be implemented in hardware and exclude carrier waves and propagated signals. That is, computer storage media for purposes of this disclosure are not signals per se.

In some examples, the processor 520 executes the computer-executable instructions to analyze vehicle data to identify a first intervention event, generate simulation data, obtain user data associated with the simulation data, analyze the user data to determine that the user data satisfies a predetermined intervention threshold, and use the simulation data to modify the vehicle data. In this manner, one or more control mechanisms (e.g., actuator 130, steering device 232, propulsion device 234, braking device 236) may be controlled based on the monitoring of the vehicle 100 and its environment 102 (e.g., using one or more sensors 110). The processor 520 may include one or more processing units (e.g., in a multi-core configuration). Although the processor 520 is shown separate from the system memory 510, examples of the disclosure contemplate that the system memory 510 may be onboard the processor 520, such as in some embedded systems.

A user or operator (e.g., user 332) may enter commands and other input into the computing system 500 through one or more input devices 530 (e.g., sensor 110, camera 211, radar device 212, lidar device 213, sonar device 214, IMU 215, odometry sensor 216, GPS device 217) coupled to the processor 520. The input devices 530 are configured to receive information (e.g., from the user). Example input devices 530 include, without limitation, a pointing device (e.g., mouse, trackball, touch pad, joystick), a keyboard, a game pad, a controller, a microphone, a camera, a gyroscope, an accelerometer, a position detector, and an electronic digitizer (e.g., on a touchscreen). Information, such as text, images, video, audio, and the like, may be presented to a user via one or more output devices 540 coupled to the processor 520. The output devices 540 are configured to convey information (e.g., to the user). Example, output devices 540 include, without limitation, a monitor, a projector, a printer, a speaker, a vibrating component. In some examples, an output device 540 is integrated with an input device 530 (e.g., a capacitive touch-screen panel, a controller including a vibrating component).

One or more network components 550 may be used to operate the computing system 500 in a networked environment using one or more logical connections. Logical connections include, for example, local area networks and wide area networks (e.g., the Internet). The network components 550 allow the processor 520, for example, to convey information to and/or receive information from one or more remote devices, such as another computing system or one or more remote computer storage media. Network components 550 may include a network adapter, such as a wired or wireless network adapter or a wireless data transceiver.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

Example driving automation systems and trainer systems for use with driving automation systems are described herein and illustrated in the accompanying drawings. This written description uses examples to disclose aspects of the disclosure and also to enable a person skilled in the art to practice the aspects, including making or using the above-described systems and executing or performing the above-described methods. One purpose of the example trainer systems described herein is to test the environment of a vehicle using simulations and crowdsourcing. In this manner, opportunities to improve the systems described herein may be readily identified. Examples described herein may be used to generate one or more training simulations from real-world data, determine whether a takeover situation (e.g., intervening event) has occurred, and (3) use data regarding the takeover situation to generate new code.

Having described aspects of the disclosure in terms of various examples with their associated operations, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense. For example, the examples described herein may be implemented and utilized in connection with many other applications such as, but not limited to, other automated systems.

Components of the systems and/or operations of the methods described herein may be utilized independently and separately from other components and/or operations described herein. Moreover, the methods described herein may include additional or fewer operations than those disclosed, and the order of execution or performance of the operations described herein is not essential unless otherwise specified. That is, the operations may be executed or performed in any order, unless otherwise specified, and it is contemplated that executing or performing a particular operation before, contemporaneously with, or after another operation is within the scope of the disclosure. Although specific features of various examples of the disclosure may be shown in some drawings and not in others, this is for convenience only. In accordance with the principles of the disclosure, any feature of a drawing may be referenced and/or claimed in combination with any feature of any other drawing.

When introducing elements of the disclosure or the examples thereof, the articles “a,” “an,” “the,” and “said” are intended to mean that there are one or more of the elements. References to an “embodiment” or an “example” of the present disclosure are not intended to be interpreted as excluding the existence of additional embodiments or examples that also incorporate the recited features. The terms “comprising,” “including,” and “having” are intended to be inclusive and mean that there may be elements other than the listed elements. The phrase “one or more of the following: A, B, and C” means “at least one of A and/or at least one of B and/or at least one of C.”

The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of training an automated driver system, the method comprising:
analyzing vehicle data to identify an intervention event, a portion of the vehicle data corresponding to the intervention event including first control data and first environment data;
using the portion of the vehicle data corresponding to the intervention event to generate simulation data including second control data and second environment data;
obtaining user data associated with the simulation data;
analyzing the user data to determine whether the user data satisfies a predetermined intervention threshold; and
on condition that the user data satisfies the predetermined intervention threshold, using the user data to modify the first control data.

2. The method of claim 1, comprising communicating with a vehicle system to obtain the vehicle data.

3. The method of claim 1, comprising communicating with a simulation system to present one or more simulations to one or more users, wherein the user data is obtained in response to presenting the one or more simulations.

4. The method of claim 1, wherein the portion of the vehicle data corresponding to the intervention event is used to generate first simulation data for presenting a first simulation to a first user and second simulation data for presenting a second simulation to a second user.

5. The method of claim 1, wherein the portion of the vehicle data corresponding to the intervention event is used to generate first simulation data corresponding to a first situation and second simulation data corresponding to a second situation.

6. The method of claim 1, comprising removing the first control data.

7. A trainer device for use in training an automated driver system, the trainer device comprising:
a vehicle manager that manages data associated with controlling a vehicle, the vehicle manager configured to analyze vehicle data to identify an intervention event, a portion of the vehicle data corresponding to the intervention event including first control data and first environment data; and
a simulation manager that manages data associated with simulating the vehicle, the simulation manager obtaining the portion of the vehicle data corresponding to the intervention event to generate simulation data including second control data and second environment data, obtain user data associated with the simulation data, analyze the user data to determine whether the user data satisfies a predetermined intervention threshold, and on condition that the user data satisfies the predetermined intervention threshold, transmit the user data to the vehicle manager for modifying the first control data.

8. The trainer device of claim 7, wherein the vehicle manager obtains the vehicle data from a vehicle system.

9. The trainer device of claim 7, wherein the simulation manager generates the second control data based on the first control data and the second environment data based on the first environment data.

10. The trainer device of claim 7, wherein the simulation manager uses the simulation data to present one or more simulations to one or more users, wherein the user data is obtained in response to presenting the one or more simulations.

11. The trainer device of claim 7, wherein the simulation manager generates first simulation data and second simulation data, transmits the first simulation data to a first simulation system to present a first simulation to a first user, and transmits the second simulation data to a second simulation system to present a second simulation to a second user.

12. The trainer device of claim 7, wherein the simulation manager generates first simulation data corresponding to a first situation and second simulation data corresponding to a second situation.

13. The trainer device of claim 7, wherein the vehicle manager removes the first control data.

14. The trainer device of claim 7, wherein the vehicle manager generates third control data based on the user data.

15. A system comprising:
a vehicle comprising a plurality of sensors, a plurality of actuators, and an automated driver controller coupled to the plurality of sensors and the plurality of actuators for controlling one or more dynamic driving tasks; and
a trainer device coupled to the automated driver controller, the trainer device configured to analyze vehicle data to identify an intervention event, use a portion of the vehicle data corresponding to the intervention event to generate simulation data, obtain user data associated with the simulation data, analyze the user data to determine whether the user data satisfies a predetermined intervention threshold, and on condition that the user data satisfies the predetermined intervention threshold, modify the vehicle data.

16. The system of claim 15, wherein the trainer device generates environment data based on an environment of the vehicle, and control data for navigating the environment of the vehicle.

17. The system of claim 15, wherein the trainer device uses the simulation data to present one or more simulations to one or more users, wherein the user data is obtained in response to presenting the one or more simulations.

18. The system of claim 15, wherein the trainer device generates first simulation data and second simulation data, uses the first simulation data to present a first simulation to a first user, and uses the second simulation data to present a second simulation to a second user.

19. The system of claim 15, wherein the trainer device generates first simulation data corresponding to a first situation and second simulation data corresponding to a second situation.

20. The system of claim 15, wherein the automated driver controller removes control data based on the user data.
